(19) United States
(12) Patent Application Publication
(10) Pub. No.: US 2023/0145762 A1
(43) Pub. Date: May 11, 2023

(54) TAMPER RESISTANT PLUG

(71) Applicant: S&C Electric Company, Chicago, IL (US)

(72) Inventors: Eliseo Navarrete, Chicago, IL (US); Lawrence S. Semel, Chicago, IL (US); James F. Fargo, Winnetka, IL (US); Rahul Jain, Evanston, IL (US)

(73) Assignee: S&C Electric Company, Chicago, IL (US)

(21) Appl. No.: 17/963,872

(22) Filed: Oct. 11, 2022

Related U.S. Application Data
(60) Provisional application No. 63/278,215, filed on Nov. 11, 2021.

(51) Int. Cl. H02B 13/045

(52) U.S. Cl. CPC H02B 13/045

(57) ABSTRACT

A tamper resistant plug that has particular application for sealing a fill port in a hermetically sealed and gas-insulated tank associated with medium-voltage switchgear. The plug includes a body portion and a top annular rim defining a central recess and having an internal surface facing the recess, where the internal surface has a polygon shape with only rounded edges. In one embodiment, the polygon shape is a trilobe.

### CROSS-REFERENCE TO RELATED APPLICATION

This application claims the benefit of priority from the U.S. Provisional Application No. 63/278,215, filed on Nov. 11, 2021, the disclosure of which is hereby expressly incorporated herein by reference for all purposes.

### BACKGROUND

### Field

This disclosure relates generally to a tamper resistant plug and, more particularly, to a tamper resistant plug for a hermetically sealed tank associated with medium-voltage switchgear, where the plug includes a polygon shaped interface surface with only rounded edges.

### Discussion of the Related Art

An electrical power distribution network, often referred to as an electrical grid, typically includes a number of power generation plants each having a number of power generators, such as gas turbines, nuclear reactors, coal-fired generators, hydro-electric dams, etc. The power plants provide power at a variety of medium voltages that are then stepped up by transformers to a high voltage AC signal to be connected to high voltage transmission lines that deliver electrical power to a number of substations typically located within a community, where the voltage is stepped down to a medium voltage for distribution. The substations provide the medium voltage power to a number of three-phase feeders including three single-phase feeders that carry the same current, but are 120° apart in phase. A number of three-phase and single phase lateral lines are tapped off of the feeder that provide the medium voltage to various distribution transformers, where the voltage is stepped down to a low voltage and is provided to a number of loads, such as homes, businesses, etc. Some power distribution networks may employ a number of underground single-phase lateral circuits that feed residential and commercial customers. Often times these circuits are configured in a loop and fed from power sources at both ends, where an open circuit location in the loop isolates the two power sources.

Power distribution networks of the type referred to above typically include a number of switching devices, breakers, reclosers, current interrupters, etc. that control the flow of power throughout the network. Standalone pad mounted and underground switchgear including electrical disconnect switches, fuses and/or circuit breakers used to control, protect and isolate electrical equipment are often employed to de-energize equipment to allow work to be done and to clear faults. Switchgear often include load-interrupter switches, resettable, vacuum fault interrupters and other equipment that are enclosed in a hermetically sealed and gas-insulated steel tank to provide electrical isolation. The tank is generally filled with a blend of CO₂ and 3M™ Novec™ 4710 insulating gas (CO₂-Novec) through a fill port, and the fill port is subsequently sealed with a plug, where the plug is designed to be opened with a special tool. However, the plug in existing switchgear tanks can generally be opened with a flat head screwdriver or other commonly available tool. Even though these tanks are hermetically sealed at the factory, they can leak over time, which would lead the owner of the switchgear to remove the plug using these tools and refill the tank, possibly with the wrong insulating gas, such as SF₆.

Hermetically sealed gas-insulated equipment (GIE) can be defined under regulations as being pre-charged with covered insulating gas, sealed at the factory and designed by the manufacturer to not be fillable by the GIE owner or a third-party designee. In order to meet this definition of hermetically sealed GIE, the plug for these tanks needs to be redesigned such that it is not able to be removed by the equipment owner or a third-party designee and filled with insulating gas.

### SUMMARY

The following discussion discloses and describes a tamper resistant plug that has particular application for sealing a fill port in a hermetically sealed and gas-insulated tank associated with medium-voltage switchgear. The plug includes a body portion and a top annular rim defining a central recess and having an internal surface facing the recess, where the internal surface has a polygon shape with only rounded edges. In one embodiment, the polygon shape is a trilobe.

Additional features of the disclosure will become apparent from the following description and appended claims, taken in conjunction with the accompanying drawings.

### BRIEF DESCRIPTION OF THE DRAWINGS

FIG. 1 is an isometric view of medium-voltage switchgear including a hermetically sealed and gas insulated tank;

FIG. 2 is a cutaway isometric view of the tank in the switchgear shown in FIG. 1 and illustrating a fill port sealed with a tamper resistant plug;

FIG. 3 is a side view of the tamper resistant plug separated from the fill port;

FIG. 4 is a top view of the tamper resistant plug separated from the fill port; and

FIG. 5 is an isometric view of a specially configured tool operable to be seated in the plug for rotating the plug.

### DETAILED DESCRIPTION OF THE EMBODIMENTS

The following discussion of the embodiments of the disclosure directed to a tamper resistant plug is merely exemplary in nature, and is in no way intended to limit the disclosure or its applications or uses. For example, the tamper resistant plug has particular application for sealing a fill port of a hermetically sealed and gas-insulated tank in medium-voltage switchgear. However, as will appreciated by those skilled in the art, the plug may have application for sealing other enclosures.

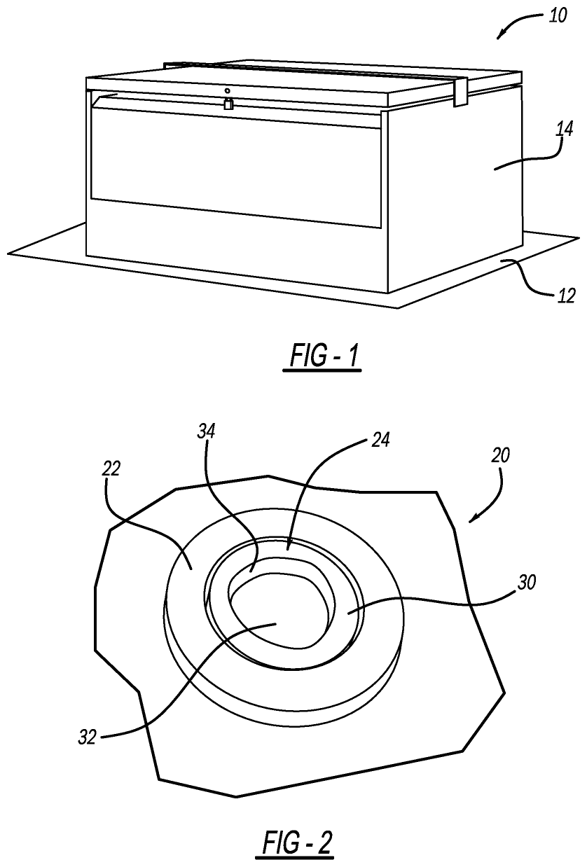

FIG. 1 is an isometric view of medium-voltage switchgear 10 mounted on a pad 12 and including an enclosure 14. The switchgear 10 is intended to represent any suitable switchgear employed in an electrical power distribution network as discussed above, and can include any and all components for a particular application.

FIG. 2 is a cutaway isometric view of a hermetically sealed steel tank 20 that can be used in the switchgear 10 shown in FIG. 1. Typically, vacuum circuit breakers, disconnect switches and other components and electrical equipment (not shown) associated with the operation of the switchgear 10 would be enclosed in the tank 20 to provide the equipment in a gas-insulated environment. The tank 20 is filled with an insulating gas, such as CO₂-Novec, through a circular, threaded fill port 22 during manufacture of the switchgear 10, and the fill port 22 is sealed with a circular, tamper resistant steel plug 24.

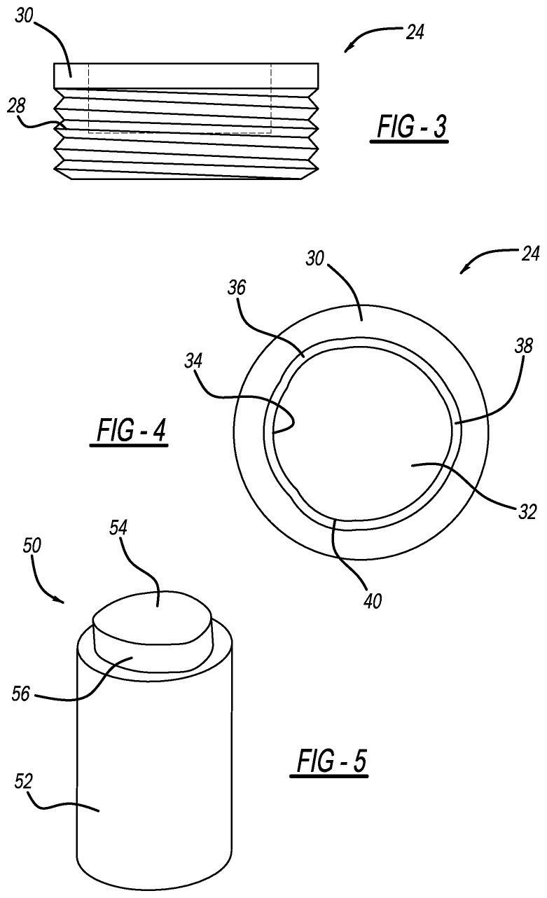

FIG. 3 is a side view and FIG. 4 is a top view of the plug 24 separated from the tank 20. The plug 24 includes a threaded body portion 28 that attaches to the threaded fill port 22 to allow the plug 24 to be rotated and be inserted and removed from the fill port 22. The plug 24 also includes an outer top annular rim 30 that defines a recess 32 in the top of the plug 24. An inner surface 34 of the rim 30 facing the recess 32 has a specially configured shape that prevents off-the-shelf, readily available and/or common tools, such as screw drivers, sockets, pliers, channel locks, etc., from engaging the rim 30 in a manner that allows the tool to rotate the plug 24 and remove it from the fill port 22. Particularly, the inner surface 34 has a polygonal shape with only rounded edges, i.e., no corners or flat edges, that might otherwise allow the common tool to engage the surface 34. In one embodiment, the polygonal shape is a trilobe defined by lobe indentations 36, 38 and 40. Therefore, the plug 24 cannot generally be removed from the fill port 22 by an owner of the switchgear 10 after the switchgear 10 has left the factory. In one non-limiting embodiment, the recess 32 has a diameter of about 0.850″.

FIG. 5 is an isometric view of a specially designed tool 50 that is operable to engage the inner surface 34 of the rim 30 to rotate the plug 24. The tool 50 includes a cylindrical portion 52 and a head portion 54. The head portion 54 includes an outer surface 56 that is the same size and shape as the recess 32. Thus, when the head portion 54 is inserted into the recess 32, the outer surface 56 perfectly engages the inner surface 34 such then when the tool 50 is rotated, the plug 24 also rotates. Thus, the plug 24 can initially be inserted in the fill port 22 and can later be removed at the factory if the tank 20 needs to be refilled with gas.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A plug for sealing a fill port in a tank, the plug comprising:
a body portion; and
a top annular rim defining a central recess, the rim having an internal surface facing the recess, the internal surface having a polygon shape with only rounded edges.

2. The plug according to claim 1 wherein the polygon shape is a trilobe defined by three lobe indentations.

3. The plug according to claim 1 wherein the recess has a diameter of about 0.850″.

4. The plug according to claim 1 wherein the tank is a steel tank and the plug is a steel plug.

5. The plug according to claim 1 wherein the tank is part of switchgear.

6. The plug according to claim 5 wherein the switch gear is medium-voltage switchgear.

7. The plug according to claim 1 wherein the body portion is threaded.

8. A plug for sealing a fill port in a tank, the plug comprising:
a body portion; and
a top annular rim defining a central recess, the rim having an internal surface facing the recess, the internal surface having a polygon shape with no corners.

9. The plug according to claim 8 wherein the polygon shape is a trilobe defined by three lobe indentations.

10. The plug according to claim 8 wherein the recess has a diameter of about 0.850″.

11. The plug according to claim 8 wherein the tank is a steel tank and the plug is a steel plug.

12. The plug according to claim 8 wherein the tank is part of switchgear.

13. The plug according to claim 12 wherein the switch gear is medium-voltage switchgear.

14. The plug according to claim 8 wherein the body portion is threaded.

15. Switchgear including a hermetically sealed tank having a fill port and a plug for sealing the fill port, the plug comprising:
a body portion; and
a top annular rim defining a central recess, the rim having an internal surface facing the recess, the internal surface having a polygon shape with only rounded edges.

16. The switchgear according to claim 15 wherein the polygon shape is a trilobe defined by three lobe indentations.

17. The switchgear according to claim 15 wherein the recess has a diameter of about 0.850″.

18. The switchgear according to claim 15 wherein the tank is a steel tank and the plug is a steel plug.

19. The switchgear according to claim 15 wherein the switch gear is medium-voltage switchgear.

20. The switchgear according to claim 15 wherein the body portion is threaded.
